(19) United States
(12) Patent Application Publication
(10) Pub. No.: US 2010/0182899 A1
(43) Pub. Date: Jul. 22, 2010

(54) OFDM Time Basis Matching With Pre-FFT Cyclic Shift

(75) Inventors: Michael Leviant, Haifa (IL); Ido Lev, Haifa (IL); Matthias Brehler, Boulder, CO (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/467,299

(22) Filed: May 17, 2009

Related U.S. Application Data
(60) Provisional application No. 61/145,536, filed on Jan. 17, 2009.

(51) Int. Cl. H04J 11/00

(52) U.S. Cl. 370/210

(57) ABSTRACT

In OFDM communication, a pre-FFT cyclic shift is used to achieve time basis matching among symbols, and/or between symbols and their corresponding channel estimates.

### CLAIM OF PRIORITY UNDER 35 U.S.C. §119

The present Application for Patent claims priority to Provisional Application No. 61/145,536 filed Jan. 17, 2009, and assigned to the assignee hereof and hereby expressly incorporated by reference herein.

### REFERENCE TO RELATED APPLICATIONS

The present application is related to the following U.S. patent application Ser. No. 11/777,251 and Ser. No. 11/777,263, both of which are expressly incorporated by reference herein.

### BACKGROUND

1. Field

The present disclosure relates generally to wireless communication and, more particularly, to wireless communication using Orthogonal Frequency Division Multiplexing (OFDM).

2. Background

Channel Estimation (CE) is used in conventional multi-carrier systems such as DVB-H or ISDB-T to obtain an estimate of the channel frequency response for each OFDM sub-carrier and each OFDM symbol for demodulation of OFDM data symbols. Additionally, the CE provides an estimate of the channel impulse response for a time tracking algorithm. Detailed descriptions of various CE algorithms are provided in aforementioned U.S. application Ser. No. 11/777,251.

CE algorithms are based on pilot sub-carriers embedded in the transmitted signal. In order to improve CE performance, pilot information is interpolated over several consecutive symbols. During data demodulation the time tracking algorithm occasionally advances or retards the position of the FFT window in order to keep track with the transmitted signal timing. If these time adjustments are not taken into consideration by the CE algorithm, the CE performance is degraded due to the different time bases of the OFDM symbols used for pilot information interpolation.

To avoid degrading the CE performance, the OFDM symbols (or only the pilot sub-carriers) are translated to the same time basis before interpolating the pilot information. This operation is referred to as timing correction. The time-corrected pilots are interpolated to obtain the channel estimate. The time basis of this channel estimate (which is the identical time basis of all the OFDM symbols used to obtain it) may be different from the time basis of the corresponding OFDM symbol to be demodulated with the channel estimate. If this is the case, the channel estimate has to be translated to the time basis of the corresponding OFDM symbol prior to the demodulation of this OFDM symbol. This operation is referred to as matching the time basis of the channel estimate with the time basis of the OFDM symbol to be demodulated by it.

In U.S. Ser. No. 11/777,251, frequency domain pilot interpolation and time domain pilot interpolation are described. Methods for changing OFDM symbol time basis (for timing correction) and changing channel estimate time basis (for matching the channel estimate time basis to the corresponding OFDM symbol) are described. These methods involve phase operations which have to be performed by hardware or by firmware.

In the CE algorithms described in U.S. Ser. No. 11/777,251, at time n, the consecutive OFDM symbols from time m to time n (m<n) are interpolated to obtain a channel estimate for demodulating the OFDM symbol at time p (m<p<n). All the algorithms assume that when the OFDM symbol at time n (also referred to herein as “OFDM symbol n”) arrives, time-corrected versions of the pilots of OFDM symbol m to OFDM symbol n−1 are stored in memory, with their time basis matching the time basis of OFDM symbol p for which the channel estimate has to be obtained at time n. All the algorithms have the same structure, performing the following steps when OFDM symbol n arrives:
1) Obtain the difference between the time basis of OFDM symbol n and OFDM symbol p by summing all the FFT window time updates between these two symbols.
2) Translate the pilots of OFDM symbol n to the time basis of OFDM symbol p using phase operations which are performed by hardware or firmware. The phases are calculated using the result of step 1.
3) Interpolate the pilots of the time-corrected OFDM symbols m through n and obtain a channel estimate with time basis equal to that of OFDM symbol p.
4) Demodulate OFDM symbol p with the channel estimate obtained in step 3. The channel estimate time basis is equal to the time basis of OFDM symbol p.
5) Obtain the difference between the time basis of OFDM symbol p and OFDM symbol p+1. This is the FFT window time update between these two symbols.
6) Translate the pilots of OFDM symbols m+1 through n from the time basis of OFDM symbol p to the time basis of OFDM symbol p+1 using phase operations which are performed by hardware or firmware. The phases are calculated using the result of step 5. Store the time-corrected pilots of these OFDM symbols in memory. The time-corrected pilots of OFDM symbol n are stored in memory instead of the time-corrected pilots of OFDM symbol m which are no longer needed. This step matches the time basis of the next channel estimate, for OFDM symbol p+1, to the time basis of OFDM symbol p+1.

The steps above are repeated for OFDM symbol n+1 and so on.

As can be seen, existing algorithms require many phase operations. Special hardware and special firmware code are required to implement these operations. These operations complicate the design and the verification, increase power consumption and require computation time.

It is desirable in view of the foregoing to provide for simplifying the processes of timing correction among received OFDM symbols, and matching the channel estimate time basis to the time basis of the OFDM symbol to be demodulated.

### SUMMARY

A pre-FFT cyclic shift is used to achieve time basis matching in OFDM communication. Time basis matching among symbols, and/or between symbols and their corresponding channel estimates may be achieved.

### BRIEF DESCRIPTION OF THE DRAWINGS

Various aspects of a wireless communications system are illustrated by way of example, and not by way of limitation, in the accompanying drawings, wherein:

FIG. 1 shows an example of FFT window cyclic shifting according to exemplary embodiments of the present work;

FIGS. 2a-2f are timing diagrams that illustrate how FFT window cyclic shifting affects a channel impulse response estimate at the receiver;

FIGS. 3a-3b are timing diagrams that illustrate the result of a known zero padding process when applied to a channel impulse response estimate that has been affected by FFT window cyclic shifting;

FIGS. 3c-3d are timing diagrams that illustrate the desired result of the zero padding process of FIGS. 3a and 3b;

FIG. 4 shows a simplified example of an FFT window position update and corresponding cyclic shift according to exemplary embodiments of the present work;

FIG. 5 diagrammatically illustrates an OFDM receiver apparatus according to exemplary embodiments of the present work; and

FIG. 6 diagrammatically illustrates a portion of the apparatus of FIG. 5 according to exemplary embodiments of the present work.

### DETAILED DESCRIPTION

The detailed description set forth below in connection with the appended drawings is intended as a description of various embodiments of the present work and is not intended to represent the only embodiments in which the present work may be practiced. The detailed description includes specific details for the purpose of providing a thorough understanding of the present work. However, it will be apparent to those skilled in the art that the present work may be practiced without these specific details. In some instances, well known structures and components are shown in block diagram form in order to avoid obscuring the concepts of the present work.

The word “exemplary” is used herein to mean “serving as an example, instance, or illustration.” Any embodiment described herein as “exemplary” is not necessarily to be construed as preferred or advantageous over other embodiments.

Exemplary embodiments of the present work implement a time domain cyclic shift of the FFT window prior to performing the FFT. The cyclic shift is readily implemented. Some embodiments utilize a simple hardware cyclic addressing implementation. Phase operations such as described above are not required, so the design is simplified, requiring less hardware, firmware code, computation power and design verification time.

In some embodiments, the required cyclic shift is calculated by summing all the FFT window timing updates from the beginning of data demodulation to the current OFDM symbol (for which the cyclic shift is to be calculated). The FFT window of the current symbol is then cyclically shifted by the calculated shift. This operation results in translating each OFDM symbol in the received sequence to the time basis of the first OFDM symbol, so all the OFDM symbols have the same time basis. Because the cyclic shift simultaneously changes the time basis of both the pilot sub-carriers and the data sub-carriers, there is no need to match the channel estimate to the corresponding OFDM symbol to be demodulated using the channel estimate, so the cyclic shift achieves both (1) the desired timing correction among the received OFDM symbols, and (2) the desired matching of the channel estimate time basis to the time basis of the corresponding OFDM symbol to be demodulated.

Note that the cyclic shift operation is distinct from the FFT window positioning update provided by the time tracking algorithm. First, the FFT window position is advanced or retarded according to the output of the time tracking algorithm. Then, after the FFT window position is used to extract the FFT window for the current OFDM symbol, the extracted FFT window is cyclically shifted in order to change the time basis of the current OFDM symbol to the time basis of the first OFDM symbol.

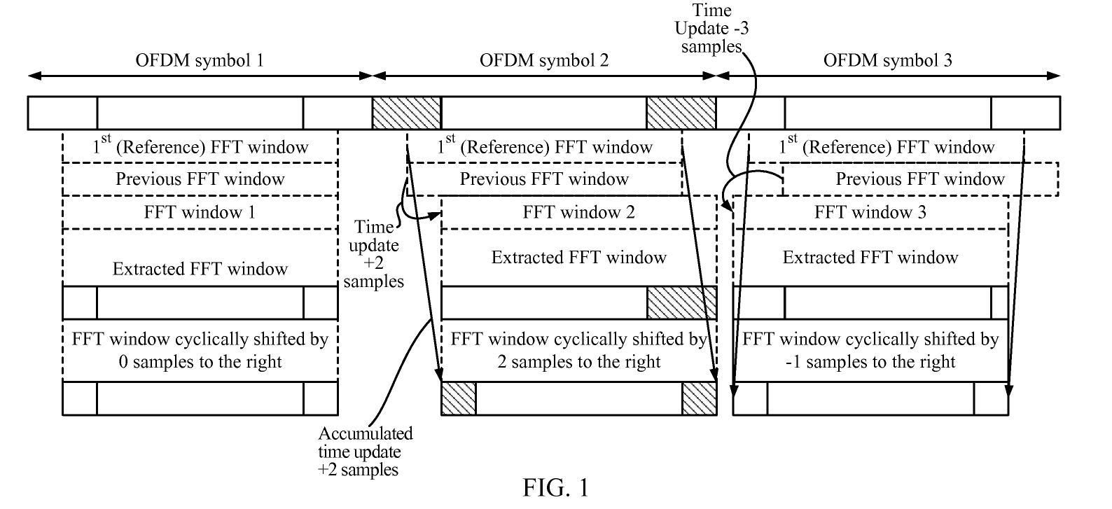

FIG. 1 shows an example of FFT window cyclic shifting according to exemplary embodiments of the present work. The algorithm starts at the first OFDM symbol, i.e., OFDM symbol 1, of a received sequence of OFDM symbols. OFDM symbol 1 will serve as a time basis reference for the rest of the symbols in the sequence. An initial FFT window position is determined for the first OFDM symbol according to any suitable conventional technique (e.g., by a timing acquisition algorithm during the signal acquisition state prior to data demodulation), and an accumulated time update value is set to an initial value of 0. The accumulated time update value represents the required cyclic shift. Thus, the cyclic shift is 0 for OFDM symbol 1, i.e., no cyclic shifting is needed. Accordingly, the FFT window for OFDM symbol 1 is extracted according to the initial FFT window position, with no cyclic shifting.

For the next successive OFDM symbol of the received sequence, OFDM symbol 2, the corresponding FFT window position is provided by the time tracking algorithm as an offset (+2 samples in the example of FIG. 1) relative to the initial FFT window position that was used for OFDM symbol 1. This offset value is added to the initial accumulated time update value to produce a new accumulated time update value of +2 (0+2) samples. This new accumulated time update value represents the cyclic shift required for OFDM symbol 2. The FFT window for OFDM symbol 2 is extracted according to the window position provided for OFDM symbol 2 by the time tracking algorithm (i.e., offset +2 samples from the initial FFT window position), and then the samples within the extracted FFT window are cyclically shifted +2 samples to the right. The cyclically shifted FFT window for OFDM symbol 2 now has the same time basis as OFDM symbol 1 (the reference symbol).

For the next successive OFDM symbol, OFDM symbol 3, the corresponding FFT window position is provided by the time tracking algorithm as an offset (−3 samples in the example of FIG. 1) relative to the FFT window position that was used for OFDM symbol 2. This offset value is added to the current accumulated time update value (+2 samples) to produce a new accumulated time update value of −1 (+2+−3) samples. This new accumulated time update value represents the cyclic shift required for OFDM symbol 3. Accordingly, the FFT window for OFDM symbol 3 is extracted according to the window position provided for OFDM symbol 3 by the time tracking algorithm (i.e., offset −3 samples from the FFT window position that was used for OFDM symbol 2), and then the samples within the extracted FFT window are cyclically shifted −1 sample to the right (effectively a cyclic shift of 1 sample to the left). The cyclically shifted FFT window for OFDM symbol 3 now has the same time basis as OFDM symbols 1 and 2, namely the time basis of OFDM symbol 1 (the reference symbol).

The foregoing process may be repeated for every OFDM symbol in the received sequence. Because cyclic shifts that differ by a multiple of the FFT window length are equivalent, some embodiments maintain the accumulated time update value modulo L, where L is the FFT window length.

As mentioned, the cyclic shift simultaneously changes the time bases of both the pilot sub-carriers (used for channel estimation) and data sub-carriers (used for demodulation). The requirement for proper demodulation—equal time basis for the channel estimate and the corresponding OFDM symbol, no mater what that equal time basis may be—is therefore met, the equal time basis being the time basis of OFDM symbol 1. Accordingly, the time basis of the channel estimate matches that of the corresponding OFDM symbol to be demodulated using that channel estimate.

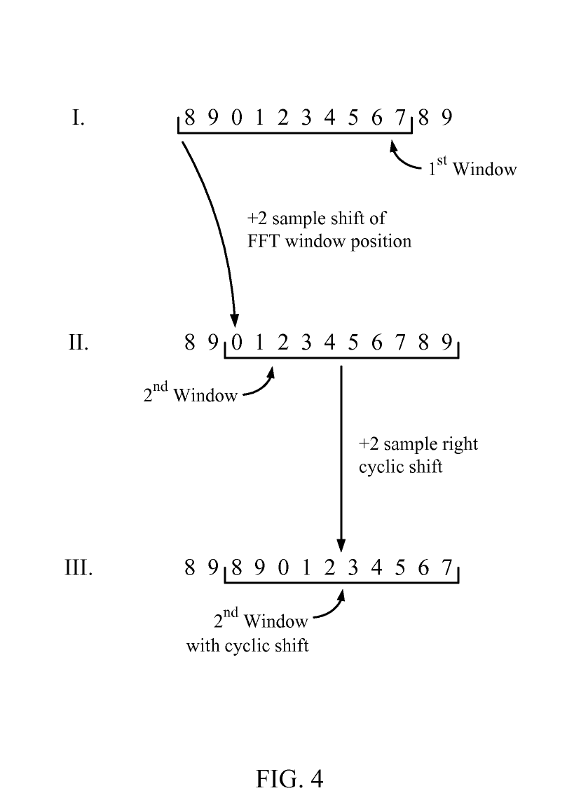

FIG. 4 shows a simplified example, for an FFT window position update of +2 samples, according to exemplary embodiments of the present work. In FIG. 4, samples corresponding to the useful OFDM symbol durations are designated 0 to 9. In the sample sequence illustrated, samples 8 and 9 are repeated at the beginning of the sequence as cyclic prefix, which is conventional in OFDM systems. The position of the first FFT window with respect to the input buffer content is shown at I. It is assumed for clarity in this example that the accumulated time update value associated with the first FFT window is O. A +2 sample shift relative to the first FFT window position shown at I results in the second FFT window position shown at II. After a +2 (i.e., 0+2) sample right cyclic shift, the shifted sequence of samples in the second FFT window is as shown at III.

In some OFDM communication systems, the pilots are interpolated in the frequency domain to obtain an estimate of the channel frequency response in the pilot sub-carriers. An estimate of the channel impulse response is obtained from this channel frequency response via inverse FFT (IFFT). The above-described cyclic shifting of samples within the FFT window affects related algorithms implemented by the system. More specifically, the time tracking algorithm, which uses the channel impulse response, is affected, as is the algorithm that interpolates between pilots to obtain the channel frequency response for OFDM symbol demodulation. These affected algorithms may be modified to remove the effects of the cyclic shift. Examples of suitable modifications are described below, wherein the following notation is used:
N_{K}: Number of sub carriers (data and pilots).
N: Receiver FFT size.
N_{IFFT}: IFFT size. This should be a power of 2 which is greater than or equal to the number of pilot sub-carriers which is equal to

$$⌊ \frac{{N}_{K}}{3} ⌋ + 1.$$

Examples include

$${N}_{IFFT} = \frac{N}{2} and {N}_{IFFT} = \frac{N}{4} .$$

F_{Bin}: OFDM bin spacing.
T_{chips1}: OFDM signal sampling interval at FFT input. That is,

$${T}_{chipx 1} = \frac{1}{{NF}_{Bin}} .$$

For demodulation, a frequency response resolution of F_{Bin} is required. The corresponding period of the impulse response in the time domain is NT_{chipx1}. However, the receiver only has a decimated measurement of the channel frequency response in the pilot tones, which are 3F_{Bin} apart. This decimation by 3 in the frequency domain folds the 3 thirds of the impulse response onto each other and reduces the time-domain period to

$$\frac{N}{3} {T}_{chipx 1} .$$

When a proper OFDM mode is used by the network, the non-zero range of the original impulse response (channel delay spread) is assumed to be shorter than the maximal guard interval whose duration is typically

$$\frac{N}{4} {T}_{chipx 1}$$

(e.g. for ISDB-T and DVB-H). Therefore, the decimation above causes no aliasing. However, the

$$\frac{N}{3} {T}_{chipx 1}$$

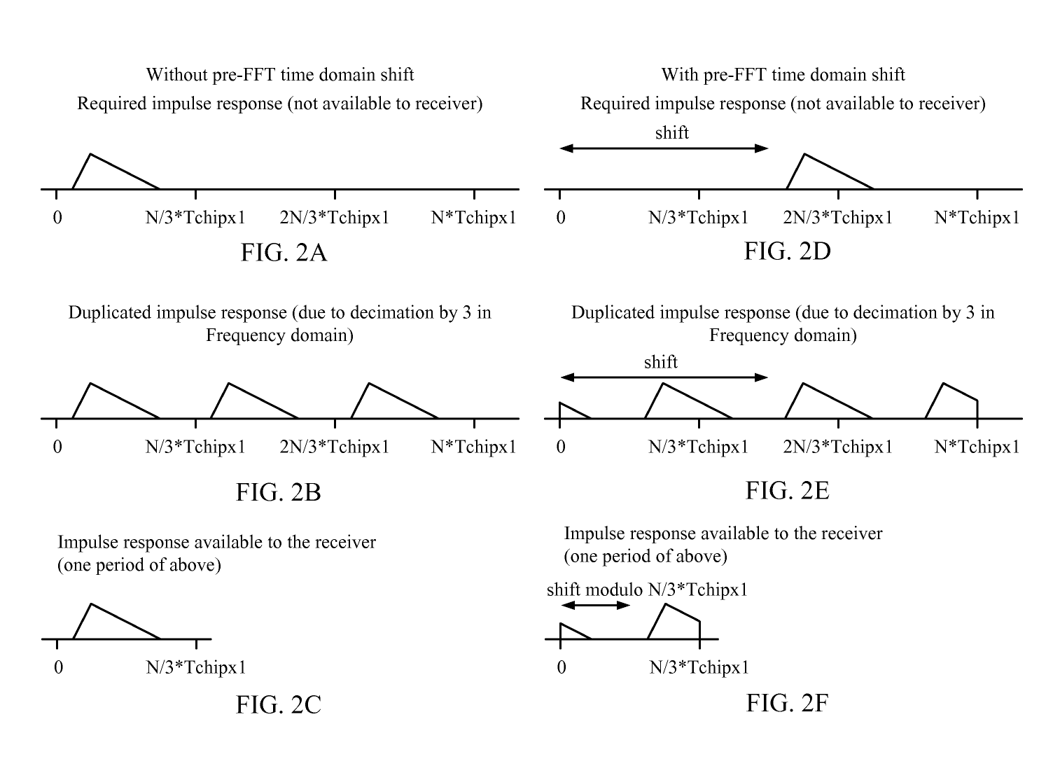

time-domain period of the channel impulse response available to the receiver is affected by the introduction of the FFT window cyclic shift (whose duration is up to NT_{chipx1}). This effect may be taken into account in the manner described below with reference to FIGS. 2a-2f.

FIGS. 2a-2c illustrate the case without the cyclic shift. FIG. 2a shows the required impulse response which is not available to the receiver. FIG. 2b shows the time domain duplication caused by the decimation by 3 in the frequency domain. There is no aliasing. FIG. 2c shows the impulse response available to the receiver, which is one period of the duplicated impulse response. The receiver has a non-shifted version of the required impulse response.

FIGS. 2d-2f show plots respectively corresponding to FIGS. 2a-2c, but for the case where a cyclic shift up to NT_{chipx1} is introduced. It is evident that the receiver has a cyclically shifted version of the required impulse response. The cyclic shift introduced to the impulse response is the cyclic shift introduced to the FFT window modulo

$$\frac{N}{3} {T}_{chipx 1} .$$

One known receiver design, also referred to as receiver A, performs the following steps:
A1. The

$$⌊ \frac{{N}_{K}}{3} ⌋ + 1$$

interpolated pilots are zero padded to length of N_{IFFT}, obtaining a frequency sampling interval of 3F_{Bin} and a frequency period of 3F_{Bin}N_{IFFT}. The zero padded pilots are converted to time domain by an N_{IFFT}-point IFFT, yielding an N_{IFFT}-samples estimate of the channel impulse response. This impulse response estimate has a sampling interval of

$$\frac{N}{3 {N}_{I F F T}} {T}_{chipx 1}$$

and a period of

$$\frac{N}{3} {T}_{chipx 1} .$$

This is the impulse response in FIG. 2c.
A2. The impulse response estimate undergoes processing such as filtering and thresholding
A3. The impulse response is used by the time tracking algorithm to determine the position of the FFT window.
A4. The frequency response is interpolated between pilots according to the following scheme, often referred to as the 3/2 FFT scheme. The impulse response is zero padded to length of 3N_{IFFT} samples, leaving its sampling interval unchanged

$$( \frac{N}{3 {N}_{I F F T}} {T}_{chipx 1} )$$

and increasing its time period to NT_{chipx1}. This results in the desired impulse response in FIG. 2a. The zero-padded impulse response is converted to frequency domain via a 3N_{IFFT}-point FFT, yielding a frequency response with frequency time interval of F_{Bin} (as required for demodulation) and a frequency period of 3N_{IFFT} bins. The interpolation scheme's name stems from the fact that, typically,

$$3 {N}_{I F F T} = \frac{3}{2} N .$$

The interpolation in step A4 above requires a 3N_{IFFT}-point FFT. For pure hardware implementation reasons, it is performed in a mathematically equivalent way which requires three N_{IFFT}-point FFTs as follows. Given an N_{IFFT}-samples impulse response {h(n)}ₙ₌₀^{N}^{_{IFFT}}⁻¹, it is desired to calculate the 3N_{IFFT}-point frequency response {(H(k)}ₖ₌₀^{3N}^{_{IFFT}}⁻¹ obtained by zero padding {h(n)}ₙ₌₀^{N}^{_{IFFT}}¹ to length of 3N_{IFFT} and performing a 3N_{IFFT}-point FFT. This may be obtained by three N_{IFFT}-point FFTs according to the following formula (one FFT for each value of m):

$${\{ H ( 3 k + m ) \}}_{k = 0}^{{N}_{I F F T} - 1} = F F T ( {\{ h ( n ) {e}^{- j \frac{2 π m}{3 {N}_{I F F T}} n} \}}_{n = 0}^{{N}_{I F F T} - 1} )$$

$$m = 0 , 1 , 2$$

The multiplication by the linear phase term prior to FFT, referred to as “phase ramping”, is implemented by hardware in receiver A.

Introducing a cyclic shift to the FFT window leads to a corresponding cyclic shift in the channel impulse response, as shown in FIG. 2d. When a cyclic shift of fftwin_shift samples is applied to the samples of the FFT window, which is sampled at T_{chipx1}, a corresponding cyclic shift of fftwin_shift·T_{chipx1} seconds is introduced to the impulse response of FIG. 2d. Thus, in FIGS. 2d-2f, “shift”=fftwin_shift·T_{chipx1}, The impulse response sampling interval in this scheme is

$$\frac{N}{3 {N}_{I F F T}} {T}_{chipx 1} ,$$

so “shift” in FIGS. 2d-2f corresponds to the following cyclic shift in samples

$$impresp\_shift = \frac{3 {N}_{I F F T}}{N} \cdot fftwin\_shift .$$

Accordingly, the cyclic shift introduced to the channel impulse response of step A1 above (shown in FIG. 2f) is given by

impresp_shift_mod=mod(impresp_shift, N_{IFFT}).

The time tracking algorithm in receiver A may be modified as follows to compensate for the effect of the cyclic shift in the FFT window. First, a counter-cyclic shift of impresp_shift_mod samples to the left is applied to the impulse response of step A1 (FIG. 2f) to remove the effect of the FFT window shift. Then, with the resulting impulse response estimate, the receiver A time tracking algorithm (beginning with the filtering/thresholding of step A2 above) is performed in the same manner described above.

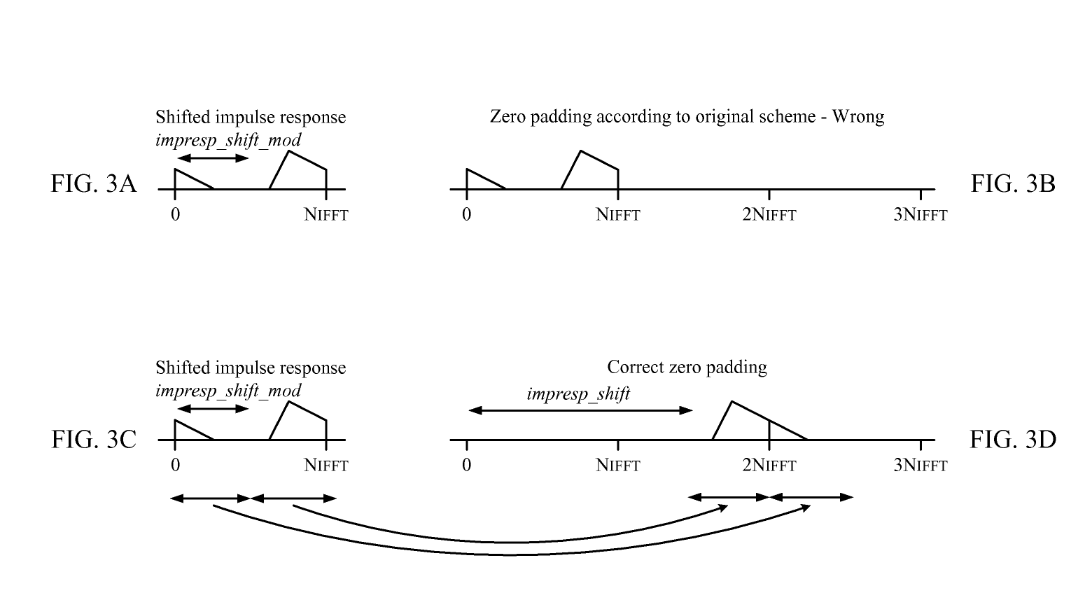

The cyclic shift introduced to the impulse response {h(n)}ₙ₌₀^{N}^{_{IFFT}}⁻¹ leads to an issue with the interpolation scheme of step A4, as described with respect to FIGS. 3a-3d. FIGS. 3a and 3b show the cyclically shifted impulse response with the zero padding of the original interpolation scheme. This zero padding is wrong. The required zero padding for the shifted impulse response is shown in the FIGS. 3c and 3d. Note that there is a zero interval between the two non-zero parts of the shifted impulse response of FIG. 3c, because the delay spread is assumed to be less than

$$\frac{N}{3} {T}_{chipx 1} .$$

If step A4 above is replaced by the following steps, the desired zero padding according to FIG. 3d is realized:
MA1. Set fftwin_shift to the accumulated time update, which is the cyclic shift applied to the current OFDM symbol.
MA2. Calculate the impulse response cyclic shift (impres_shift):

$$impresp\_shift = round ( 3 \frac{{N}_{I F F T}}{N} \cdot fftwin\_shift ) .$$

This converts fftwin_shift which is sampled at T_{chipx1} to the impulse response sampling interval which is

$$\frac{N}{3 {N}_{I F F T}} {T}_{chipx 1} .$$

(The rounding quantization error does not affect the interpolation.)
MA3. Set impresp_shift_mod=mod (impresp_shift, N_{IFFT})
MA4. Set three N_{IFFT}-point linear phase terms for m=0,1,2

$${p}_{m} ( n ) = {\{ {e}^{- j ( {Φ}_{0} ( m ) + \frac{2 π m}{3 {N}_{I F F T}} n )} \}}_{n = 0}^{{N}_{I F F T} - 1}$$

$$where {Φ}_{0} ( m ) = \frac{2 π m}{3 {N}_{I F F T}} impresp\_shift$$

MA5. Calculate the three FFT inputs {yₘ(n)}ₙ₌₀^{N}^{_{IFFT}}⁻¹ m=0,1,2 as follows:

yₘ(mod(n+impresp_shift_mod, N_{IFFT}))=h(mod(n+impresp_shift_mod, N_{IFFT}))pₘ(n)
MA6. Calculate the interpolated 3N_{IFFT}-point channel frequency response {H(k)}ₖ₌₀^{3N}^{_{IFFT}}⁻¹;

{H(3k+m)}ₖ₌₀^{N}^{_{IFFT}}¹=FFT({yₘ(n)}ₙ₌₀^{N}^{_{IFFT}}¹) m=0,1,2

The modifications according to steps MA1-MA5 may be characterized as the addition of a non-zero initial phase to the phase ramping, and the addition of a cyclic addressing mode for reading the impulse response and for writing the input to the FFT. The cyclic addressing mode uses a cyclic addressing offset which can be seen in that, for use in pm and ym above, an address corresponding to “sample n+sample offset amount” (where the sample offset amount is related to the cyclic shift, impresp_shift) is involved, instead of simply the address corresponding to sample n. The same cyclic addressing mechanism may be used to control both addresses.

As indicated above, there is a zero interval between the two non-zero parts of the shifted impulse response (see FIG. 3c). The modifications according to steps MA1-MA6 require the value of impresp_shift_mod to fall within this zero interval. Therefore an approximated value of impresp_shift_mod (and consequently approximated values of impresp_shift and fftwin_shift) will suffice. This may be utilized in steps MA1 and MA2 above.

Ideally, for steps MA1-MA6 above, the cyclic shift value applied to the current OFDM symbol would not be used for the value of fftwin_shift. Rather, a value equal to the cyclic shift that was applied to the OFDM symbol to be demodulated by the channel estimate would be used. This latter value is equal to the accumulated time update up to the OFDM symbol to be demodulated. However, the difference between the cyclic shift value that was applied to the OFDM symbol to be demodulated, and the cyclic shift value applied to the current OFDM symbol is small (sum of time updates between the OFDM symbol to be demodulated and the current OFDM symbol), so use of the current OFDM cyclic shift value is a good approximation. This is another advantage of the cyclic shift approach over known algorithms such as described in U.S. application Ser. No. 11/777,251: it need not account for the channel estimate delay (number of symbols between the current OFDM symbol and the OFDM symbol to be demodulated by the channel estimate).

Steps MA4 and MA5 suggest using continuous phase terms and cyclic indexing of the impulse response and the FFT input. This is not the only possible implementation. Any mathematically equivalent implementation could be used. Possible examples include:
1 Serial indexing of the impulse response and FFT input and cyclic indexing of the linear phase terms in step MA4.
2 Serial indexing of the impulse response and FFT input and generating a cyclically shifted (discontinuous) version of the linear phase terms in step MA4.
3 Implementation of a cyclic addressing mode by two serial addressing modes.

Another known receiver design, referred to herein as receiver B, performs the following steps:
B1. The

$$⌊ \frac{{N}_{K}}{3} ⌋ + 1$$

interpolated pilots are zero padded to length of N. The zeros are inserted between the pilots (two zeros between every two consecutive pilots) such that the pilots are located in their true positions. The sampling interval in the frequency domain is F_{Bin} and the period in the frequency domain is NF_{Bin}. The zero-padded pilots are converted to time domain by an N-point IFFT, yielding an N-samples estimate of the channel impulse response. This impulse response has time sampling interval of T_{chipx1} and a period of NT_{chipx1}. Due to the zero values between the pilots, the effective sampling interval in the frequency domain is 3F_{Bin} so the effective period of the impulse response is

$$\frac{N}{3} {T}_{chipx 1} .$$

This results in an NT_{chipx1}-long impulse response having 3 identical replicas, each

$$\frac{N}{3} {T}_{chipx 1 \_}$$

long. This is exactly FIG. 2b.
B2. The first impulse response replica is left as is. The second and third replicas are zeroed. This results in the desired impulse response of FIG. 2a (as shown in FIG. 2c).
B3. The impulse response estimate undergoes processing such as filtering and thresholding.
B4. The impulse response is used by the time tracking algorithm to position the FFT window.
B5. The impulse response is converted to frequency domain via an N-point FFT, yielding a frequency response with frequency sampling interval equal to F_{Bin} (as required for demodulation) and a frequency span of NF_{Bin}.

Introducing a cyclic shift to the FFT window leads to a corresponding cyclic shift in the channel impulse response, as shown in FIGS. 2d-2f. When a cyclic shift of fftwin_shift samples is applied to the samples within the FFT window, an identical shift of fftwin_shift samples is introduced to the impulse response of FIG. 2d, because the FFT window and impulse response share the same sampling interval. The known fftwin_shift may be used to zero the two undesired replicas in FIG. 2e. The replica which starts at fftwin_shift and lasts for N/3 samples is left as is and the other samples are all zeroed. This results in the desired impulse response of FIG. 2d.

The time tracking algorithm in receiver B may be modified as follows to compensate for the effect of the cyclic shift in the FFT window. First, a counter-cyclic shift of fftwin_shift to the left is applied to the one-replica impulse response (produced by the aforementioned zeroing in FIG. 2e). Then, with the resulting impulse response estimate, the original time tracking algorithm is performed (beginning with the filtering/thresholding of step B3 above) in the same manner described above.

The frequency response interpolation in receiver B may be modified to compensate for the effect of the cyclic shift in the FFT window by simply converting the one-replica impulse response (produced by zeroing in FIG. 2e) back to the frequency domain using an N-point FFT.

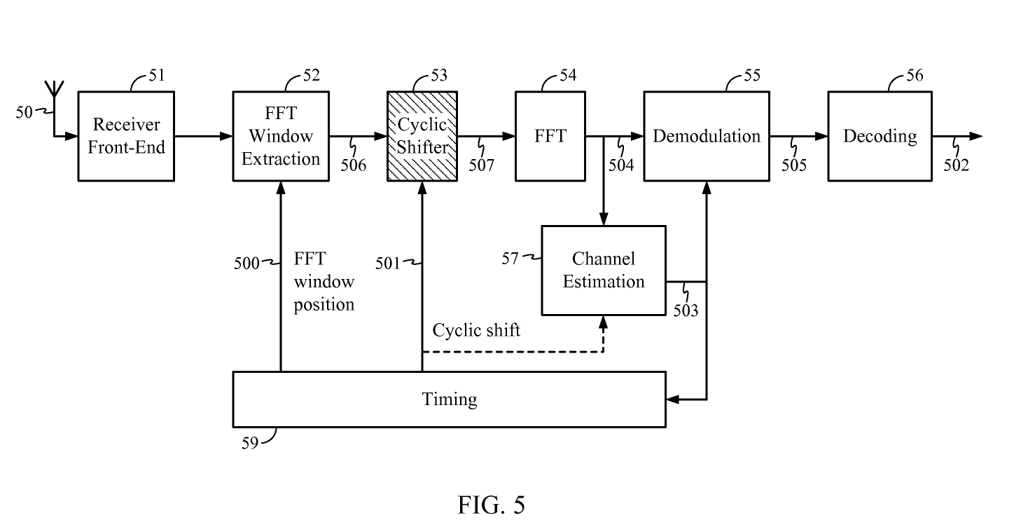

FIG. 5 diagrammatically illustrates an OFDM receiver apparatus according to exemplary embodiments of the present work. In some embodiments, the receiver apparatus is provided on a mobile platform (e.g., a cell phone, portable computing apparatus, etc.) and receives OFDM transmissions from a transmitter provided at either a fixed-site platform (e.g., a base station, Node B apparatus, access point, etc.) or another mobile platform. In some embodiments, the receiver apparatus is provided on a fixed-site platform and receives OFDM transmissions from a transmitter provided on either a mobile platform or another fixed-site platform. A sequence of OFDM symbols received by an antenna arrangement 50 is provided to a receiver front-end arrangement 51 that uses conventional techniques to produce, for each OFDM symbol, a sequence of time-domain samples at respective sample time intervals (see also FIGS. 1 and 4).

An FFT window extractor 52 uses FFT window position information 500 (produced according to a time tracking algorithm implemented in a timing control unit 59) to extract, for each OFDM symbol in the received sequence, an initial FFT window for the samples of that OFDM symbol. These initial FFT windows are designated generally at 506. A cyclic shifter 53 then cyclically shifts the samples within each of the initial FFT windows 506 as may be required by cyclic shift information 501 provided by the timing control unit 59. As described above, this cyclic shifting translates the time basis of the corresponding OFDM symbol to the time basis of the reference OFDM symbol. An FFT unit 54 performs conventional FFT processing operations with respect to the samples in the FFT windows produced at 507 by the cyclic shifter 53. For each FFT result produced at 504 by the FFT unit 54, a demodulation unit 55 uses corresponding channel estimate information 503, produced by a channel estimator 57, to demodulate the corresponding OFDM symbol according to conventional techniques. The demodulation results 505 are provided to a decoding unit 56 that uses conventional techniques to produce information bits 502 from the demodulation results.

The channel estimate information 503 is also provided to the time tracking algorithm that the timing control unit 59 implements to produce the FFT window position information 500.

In embodiments that modify the channel estimation in the manners described above relative to receivers A and B, the channel estimator 57 receives the cyclic shift information 501, as shown by broken line in FIG. 5.

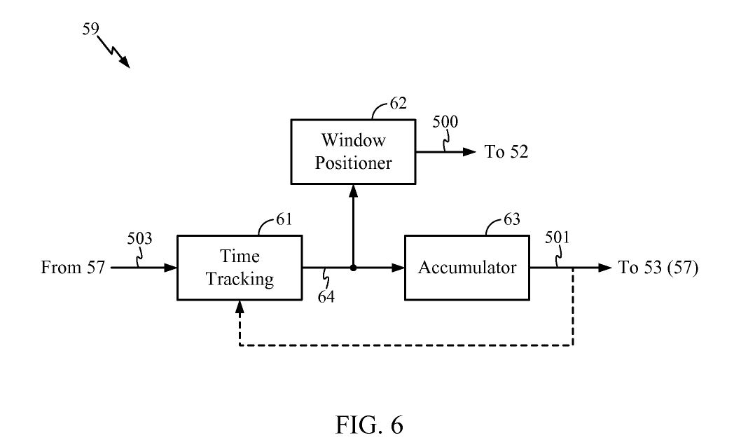

FIG. 6 diagrammatically illustrates the timing control unit 59 according to exemplary embodiments of the present work. The aforementioned time tracking algorithm, shown at 61, produces FFT window offset information 64 based on the channel estimate information 503. A window positioner 62 produces FFT window position information 500 (see also FIG. 5) in response to the FFT window offset information 64. An accumulator 63 maintains a running summation of the FFT window offset amounts produced at 64. This running summation constitutes the cyclic shift information 501, and is provided to the cyclic shifter 53. In embodiments that modify the time tracking algorithm in the manners described above relative to receivers A and B, the cyclic shift information 501 is also provided to the time tracking algorithm 61, as shown by broken line in FIG. 6.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present work.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use products that embody principles of the present work. Various modifications to these embodiments will be readily apparent to those skilled in the art, and the generic principles defined herein may be applied to other embodiments without departing from the spirit or scope of the disclosure. Thus, the present work is not intended to be limited to the embodiments shown herein but is to be accorded the widest scope consistent with the principles and novel features disclosed herein.

What is claimed is:

1. A wireless communication method, comprising:
receiving a sequence of OFDM symbols;
producing, for a target OFDM symbol within said sequence of OFDM symbols, a corresponding sequence of time domain samples at respective sample time intervals;
using a timing correction process to determine a number of said sample time intervals that approximates a timing offset between transmission and reception of the target OFDM symbol;
cyclically shifting said sequence of samples based on said number of sample time intervals to produce a further sequence of samples; and
applying FFT processing with respect to said further sequence of samples.

2. The method of claim 1, wherein consecutive ones of said OFDM symbols constitute consecutive instances of said target OFDM symbol, and including performing said producing and said using and said cyclically shifting and said applying with respect to each said instance of said target symbol.

3. The method of claim 2, including, for each said instance of said target OFDM symbol,
providing an accumulation value that represents an accumulation of said numbers of sample time intervals determined for all previous OFDM symbols in said sequence of OFDM symbols, and
updating said accumulation value to produce an updated accumulation value that accounts for said number of sample time intervals associated with said instance of said target OFDM symbol,
wherein said cyclically shifting includes, for each said instance of said target OFDM symbol, cyclically shifting the associated sequence of samples by a number of sample time intervals equal to said updated accumulation value.

4. A wireless communication apparatus, comprising:
means for receiving a sequence of OFDM symbols;
means for producing, for a target OFDM symbol within said sequence of OFDM symbols, a corresponding sequence of time domain samples at respective sample time intervals;
means for using a timing correction process to determine a number of said sample time intervals that approximates a timing offset between transmission and reception of the target OFDM symbol;
means for cyclically shifting said sequence of samples based on said number of sample time intervals to produce a further sequence of samples; and
means for applying FFT processing with respect to said further sequence of samples.

5. The apparatus of claim 4, wherein consecutive ones of said OFDM symbols constitute consecutive instances of said target OFDM symbol, and including means for performing said producing and said using and said cyclically shifting and said applying for each said instance of said target OFDM symbol.

6. The apparatus of claim 5, including means operable with respect to each said instance of said target OFDM symbol for providing an accumulation value that represents an accumulation of said numbers of sample time intervals determined for all previous OFDM symbols in said sequence of OFDM symbols, and means operable with respect to each said instance of said target OFDM symbol for updating said accumulation value to produce an updated accumulation value that accounts for said number of sample time intervals associated with said instance of said target OFDM symbol, wherein said means for cyclically shifting includes means operable with respect to each said instance of said target OFDM symbol for cyclically shifting the associated sequence of samples by a number of sample time intervals equal to said updated accumulation value.

7. A wireless communication apparatus, comprising:
an input for receiving a sequence of OFDM symbols;
a receiver front-end arrangement coupled to said input and configured to produce, for a target OFDM symbol within said sequence of OFDM symbols, a corresponding sequence of time domain samples at respective sample time intervals;
a timing controller configured to use a timing correction process to determine a number of said sample time intervals that approximates a timing offset between transmission and reception of said target OFDM symbol;
a cyclic shifter coupled to said receiver front-end arrangement and said timing controller, said cyclic shifter configured to cyclically shift said sequence of samples based on said number of sample time intervals to produce a further sequence of samples; and
an FFT unit coupled to said cyclic shifter and configured to apply FFT processing with respect to said further sequence of samples.

8. The apparatus of claim 7, wherein said receiver front-end arrangement provides consecutive ones of said OFDM symbols as consecutive instances of said target OFDM symbol, and produces, for each said instance of said target OFDM symbol, a corresponding sequence of time domain samples at respective sample time intervals, wherein said timing controller uses said timing correction process to determine, for each said instance of said target OFDM symbol, a number of said sample time intervals that approximates a timing offset between transmission and reception of said instance of said target OFDM symbol, wherein, for each said instance of said target OFDM symbol, said cyclic shifter cyclically shifts the associated sequence of samples based on the associated number of sample time intervals to produce a further sequence of samples, and wherein, for each said instance of said target OFDM symbol, said FFT unit applies FFT processing with respect to the associated further sequence of samples.

9. The apparatus of claim 8, wherein said timing controller provides, for each said instance of said target OFDM symbol, an accumulation value that represents an accumulation of said numbers of sample time intervals determined for all previous OFDM symbols in said sequence of OFDM symbols, and updates said accumulation value to produce an updated accumulation value that accounts for said number of sample time intervals associated with said instance of said target OFDM symbol, and wherein, for each said instance of said target OFDM symbol, said cyclic shifter cyclically shifts the associated sequence of samples by a number of sample time intervals equal to said updated accumulation value.

10. A computer program product for supporting wireless communication, comprising:
a computer-readable medium comprising:
code for causing at least one data processor to produce, for a target OFDM symbol within a received sequence of OFDM symbols, a corresponding sequence of time domain samples at respective sample time intervals;
code for causing the at least one data processor to use a timing correction process to determine a number of said sample time intervals that approximates a timing offset between transmission and reception of the target OFDM symbol;
code for causing the at least one data processor to cyclically shift said sequence of samples based on said number of sample time intervals to produce a further sequence of samples; and
code for causing the at least one data processor to apply FFT processing with respect to said further sequence of samples.

11. The computer program product of claim 10, wherein consecutive ones of said OFDM symbols constitute consecutive instances of said target OFDM symbol, and wherein said computer readable medium includes code for causing said at least one data processor to perform said producing and said using and said cyclically shifting and said applying with respect to each said instance of said target symbol.

12. The computer program product of claim 11, wherein said computer readable medium includes code for causing the at least one data processor to, for each said instance of said target OFDM symbol,
provide an accumulation value that represents an accumulation of said numbers of sample time intervals determined for all previous OFDM symbols in said sequence of OFDM symbols,
update said accumulation value to produce an updated accumulation value that accounts for said number of sample time intervals associated with said instance of said target OFDM symbol, and
cyclically shift the associated sequence of samples by a number of sample time intervals equal to said updated accumulation value.

13. A wireless communication method, comprising:
receiving a sequence of OFDM symbols;
producing for each of said OFDM symbols a corresponding sequence of time domain samples at respective sample time intervals;
for at least one said OFDM symbols,
translating a time basis associated with said at least one OFDM symbol to produce a corresponding time basis-translated OFDM symbol, including cyclically shifting the corresponding sequence of samples to produce a further sequence of samples; and
applying FFT processing with respect to said further sequence of samples.

14. The method of claim 13, wherein said cyclically shifting includes cyclically shifting the sequence of samples by a number of said sample time intervals that is based on an estimated timing offset between transmission and reception of said at least one OFDM symbol.

15. A wireless communication apparatus, comprising:
means for receiving a sequence of OFDM symbols;
means for producing for each of said OFDM symbols a corresponding sequence of time domain samples at respective sample time intervals;
means operable with respect to at least one said OFDM symbols for translating a time basis associated with said at least one OFDM symbol to produce a corresponding time basis-translated OFDM symbol, including means for cyclically shifting the corresponding sequence of samples to produce a further sequence of samples; and
means for applying FFT processing with respect to said further sequence of samples.

16. The apparatus of claim 15, wherein said means for cyclically shifting includes means for cyclically shifting the sequence of samples by a number of said sample time intervals that is based on an estimated timing offset between transmission and reception of said at least one OFDM symbol.

17. A wireless communication apparatus, comprising:
an input for receiving a sequence of OFDM symbols;
a receiver front-end apparatus coupled to said input and configured to produce, for each of said OFDM symbols, a corresponding sequence of time domain samples at respective sample time intervals;
a cyclic shifter coupled to said receiver front-end apparatus and configured to cyclically shift the sequence of samples associated with at least one of said OFDM symbols to produce a further sequence of samples that represents a time basis translation of said at least one OFDM symbol; and
an FFT unit coupled to said cyclic shifter and configured to apply FFT processing with respect to said further sequence of samples.

18. The apparatus of claim 17, wherein said cyclic shifter cyclically shifts said sequence of samples by a number of said sample time intervals that is based on an estimated timing offset between transmission and reception of said at least one OFDM symbol.

19. A computer program product for supporting wireless communication, comprising:
a computer-readable medium comprising:
code for causing at least one data processor to produce, for each OFDM symbol within a received sequence of OFDM symbols, a corresponding sequence of time domain samples at respective sample time intervals;
code for causing the at least one data processor to translate a time basis of at least one of said OFDM symbols to produce a corresponding time basis-translated OFDM symbol, including code for causing the at least one data processor to cyclically shift the corresponding sequence of samples to produce a further sequence of samples; and
code for causing the at least one data processor to apply FFT processing with respect to said further sequence of samples.

20. The computer program product of claim 19, wherein said computer readable medium includes code for causing the at least one data processor to cyclically shift the sequence of samples associated with said at least one OFDM symbol by a number of said sample time intervals that is based on an estimated timing offset between transmission and reception of said at least one OFDM symbol.
